(19) United States
(12) Patent Application Publication
(10) Pub. No.: US 2025/0254365 A1
(43) Pub. Date: Aug. 7, 2025

(54) VIDEO DECODER WITH LOOP FILTER-BYPASS

(71) Applicant: Telefonaktiebolaget LM Ericsson (publ), Stockholm (SE)

(72) Inventors: Jacob STRÖM, Stockholm (SE); Martin PETTERSSON, Vallentuna (SE); Rickard SJÖBERG, Stockholm (SE); Mitra DAMGHANIAN, Upplands-Bro (SE)

(73) Assignee: Telefonaktiebolaget LM Ericsson (publ), Stockholm (SE)

(21) Appl. No.: 18/855,163

(22) PCT Filed: Apr. 6, 2023
(86) PCT No.: PCT/EP2023/059289

§ 371 Date: Oct. 8, 2024

Related U.S. Application Data
(60) Provisional application No. 63/329,686, filed on Apr. 11, 2022.

(51) Int. Cl. H04N 19/82; H04N 19/117; H04N 19/167; H04N 19/172; H04N 19/86

(52) U.S. Cl. CPC H04N 19/82; H04N 19/117; H04N 19/167; H04N 19/172; H04N 19/86

(57) ABSTRACT

A method performed by an apparatus comprising a decoder, where the method includes deriving a first set of post-reconstruction samples from a bitstream. The method also includes outputting (e.g., sending out or making available for retrieval) the first set of post-reconstruction samples (e.g., outputting a copy of the first set of post-reconstruction samples to a post-filter). The method also includes filtering the first set post-reconstruction samples using one or more loop filters to produce last loop filter output samples, wherein the last loop filter output samples are not identical to the first set of post-reconstruction samples. The method also include storing the last loop filter output samples in a decoded picture buffer.

### TECHNICAL FIELD

Disclosed are embodiments related to video decoding.

### BACKGROUND

### 1. Versatile Video Coding (VVC)

Versatile Video Coding (VVC) and its predecessor, High Efficiency Video Coding (HEVC), are block-based video codecs standardized and developed jointly by ITU-T and MPEG. The codecs utilize both temporal and spatial prediction. VVC and HEVC are similar in many aspects. Spatial prediction is achieved using intra (I) prediction from within the current picture. Temporal prediction is achieved using uni-directional (P) or bi-directional inter (B) prediction on the block level from previously decoded reference pictures.

In the encoder, the difference between the original pixel data and the predicted pixel data, referred to as the residual, is transformed into the frequency domain, quantized and then entropy coded before transmitted together with necessary prediction parameters such as prediction mode and motion vectors, also entropy coded. The decoder performs entropy decoding, inverse quantization, and inverse transformation to obtain the residual, and then adds the residual to an intra or inter prediction to reconstruct a picture.

The VVC version 1 specification was published as Rec. ITU-T H.266|ISO/IEC 23090-3, “Versatile Video Coding,” in 2020. MPEG and ITU-T are working together within the Joint Video Exploratory Team (JVET) on updated versions of HEVC and VVC as well as the successor to VVC, i.e., the next generation video codec.

### 2. Components

A video sequence consists of a series of pictures where each picture consists of one or more components. A picture in a video sequence is sometimes denoted ‘image’ or ‘frame’. Each component in a picture can be described as a two-dimensional rectangular array of sample values (or “samples” for short). It is common that a picture in a video sequence consists of three components; one luma component Y where the sample values are luma values and two chroma components Cb and Cr, where the sample values are chroma values. Other common representations include ICtCb, IPT, constant-luminance YCbCr, YCoCg and others. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as ‘color components’, and other times as ‘channels’.

### 3. Blocks and Units

In many video coding standards, such as HEVC and VVC, each component of a picture is split into blocks and the coded video bitstream consists of a series of coded blocks. A block is a two-dimensional array of values. It is common in video coding that the picture is split into units that cover a specific area of the picture. Each unit consists of all blocks from all components that make up that specific area and each block belongs fully to one unit. The macroblock in H.264 and the Coding unit (CU) in HEVC and VVC are examples of units.

A block can be as a two-dimensional array that a transform used in coding is applied to. These blocks are known under the name “transform blocks.” A block can also be a two-dimensional array that a single prediction mode is applied to. These blocks can be called “prediction blocks.”

### 4. VVC Block Structure

The VVC video coding standard uses a block structure referred to as quadtree plus binary tree plus ternary tree block structure (QTBT+TT) where each picture is first partitioned into square blocks called coding tree units (CTU). The size of all CTUs are identical and the partition is done without any syntax controlling it. Each CTU is further partitioned into coding units (CU) that can have either square or rectangular shapes. The CTU is first partitioned by a quad tree structure, then it may be further partitioned with equally sized partitions either vertically or horizontally in a binary structure to form coding units (CUs). A block could thus have either a square or rectangular shape. The depth of the quad tree and binary tree can be set by the encoder in the bitstream. The ternary tree (TT) part adds the possibility to divide a CU into three partitions instead of two equally sized partitions; this increases the possibilities to use a block structure that better fits the content structure in a picture.

### 5. NAL Units

Both VVC and HEVC define a Network Abstraction Layer (NAL). All the data, i.e. both Video Coding Layer (VCL) or non-VCL data in HEVC and VVC is encapsulated in NAL units. A VCL NAL unit contains data that represents picture sample values. A non-VCL NAL unit contains additional associated data such as parameter sets and supplemental enhancement information (SEI) messages. The NAL unit in VVC and HEVC begins with a header called the NAL unit header.

### 6. Slices

The concept of slices in HEVC divides the picture into independently coded slices, where decoding of one slice in a picture is independent of other slices of the same picture. Different coding types could be used for slices of the same picture, i.e. a slice could either be an I-slice, P-slice or B-slice. One purpose of slices is to enable resynchronization in case of data loss. In HEVC, a slice is a set of CTUs.

In VVC, a slice is defined as an integer number of complete tiles or an integer number of consecutive complete CTU rows within a tile of a picture that are exclusively contained in a single NAL unit. In VVC, a picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit. In an early draft of the VVC specification, slices were referred to as tile groups.

### 7. Residuals Transforms and Quantization

A residual block consists of samples that represents value differences between sample values of the original source blocks and the prediction blocks. The residual block is typically processed using a spatial transform. In the encoder, the transform coefficients are quantized according to a quantization parameter (QP) which controls the precision of the quantized coefficients. The quantized coefficients can be referred to as residual coefficients. A high QP value would result in low precision of the coefficients and thus low fidelity of the residual block. A decoder receives the residual coefficients, applies inverse quantization and inverse transform to derive the residual block.

### 8. Coding Tools

A video codec includes a set of coding tools, where a coding tool may be described as a distinct feature of the codec that typically improves compression or decreases the complexity of the decoding. Coding tools can typically be turned on or off on a sequence level, picture level and block level to balance the compression efficiency and complexity.

Examples of coding tools that are new to VVC compared to HEVC include Luma Mapping with Chroma Scaling (LMCS), Adaptive Loop Filter (ALF), Dependent Quantization (DQ), Low Frequency Non-Separable Transform (LFNST), Adaptive Motion Vector Resolution (AMVR), Decoder-side Motion Vector Resolution (DMVR), Bi-Directional Optical Flow (BDOF), Flexible block partitioning with multi-type Tree (MTT), Cross-Component Linear Model (CCLM), Intra Block Copy (IBC), Reference Picture Resampling (RPR), Matrix Based Intra Prediction (MIP), Combined Intra/Inter Prediction (CIIP) and affine motion compensation.

### 9. Loop Filtering

In VVC, the decoding of a picture is carried out in two stages: Reconstruction and loop filtering. In the reconstruction decoding stage, the samples of the components (Y, Cb and Cr) are partitioned into rectangular blocks. As an example, one block may be of size 4×8 samples, whereas another block may be of size 64×64 samples. The decoder obtains instructions for how to reconstruct each block. This involves deriving a prediction for each block, for instance by deriving samples (e.g., copying samples) from a previously decoded picture (an example of temporal prediction (inter prediction)) or deriving samples (e.g., copying samples) from already decoded parts of the current picture (an example of intra prediction), or a combination thereof. Previously decoded pictures are stored in what is known as the decoded picture buffer (DPB). Pictures that are inter predicted thus fetches samples from the DPB for the prediction. In addition to deriving a prediction for each block, the decoder may also obtain a residual, often encoded using transform coding such as discrete sine or cosine transform, (DST or DCT). This residual is added to the prediction, and the decoder can proceed to decode the next block.

The output from the reconstruction decoding stage is the three components Y, Cb and Cr. At this stage, the samples are often called reconstructed samples, so we denote them with Y_{REC}, Cb_{REC} and Cr_{REC}. However, it is possible to further improve the quality of these components, and this is done in the loop filtering stage. The loop filtering stage in VVC consists of three sub-stages; a deblocking filter sub-stage, a sample adaptive offset filter (SAO) sub-stage, and an adaptive loop filter (ALF) sub-stage. In the deblocking filter sub-stage, the decoder changes Y_{REC}, Cb_{REC} and Cr_{REC} by smoothing edges near block boundaries when certain conditions are met. The output of this stage is denoted Y_{DBL}, Cb_{DBL} and Cr_{DBL}. The deblocking stage increases perceptual quality (subjective quality) since the human visual system is very good at detecting regular edges such as block artifacts along block boundaries. In the SAO sub-stage, the decoder adds or subtracts a signaled value to samples that meet certain conditions, such as being in a certain value range (band offset SAO) or having a specific neighborhood (edge offset SAO). This can reduce ringing noise since such noise often aggregate in certain value range or in specific neighborhoods (e.g., in local maxima). This increases objective quality (measured, for instance, using mean square error) as well as subjective quality under certain circumstances. In this document we will denote the reconstructed picture component that are the result of this stage Y_{SAO}, Cb_{SAO}, Cr_{SAO}.

The third sub-stage of the loop filtering stage is adaptive loop filtering, ALF. The basic idea behind adaptive loop filtering is that the fidelity of the picture components Y_{SAO} Cb_{SAO} and Cr_{SAO} can often be improved by filtering the picture using a linear filter that is signaled from the encoder to the decoder. As an example, by solving a least-squares problem, the encoder can figure out what coefficients a linear filter should have in order to lower the error as much as possible between the reconstructed picture components so far, Y_{SAO}, Cb_{SAO}, Cr_{SAO}, and the original picture components Y_{org}, Cb_{org} and Cr_{org}. These coefficients can then be signaled from the encoder to the decoder. The decoder reconstructs the picture as described above, applies deblocking filtering and SAO to get Y_{SAO}, Cb_{SAO}, and Cr_{SAO}, obtains the filter coefficients from the bitstream and then applies the filter to get the final output, which we will denote Y_{ALF}, Cb_{ALF}, Cr_{ALF}.

In VVC, the ALF is more advanced than this. To start with, it is observed that it is often advantageous to filter some samples with one set of coefficients, but avoid filtering other samples, or perhaps filter those other samples with another set of coefficients. To that end, VVC classifies every Y sample (i.e., every luma sample) into one of 25 classes. Which class a sample belongs to is decided for each 4×4 block of samples based on the local neighborhood of that sample block (6×6 neighborhood), specifically on the gradients of surrounding samples and the activity of surrounding samples. It is possible for the encoder to signal one set of coefficients for each of the 25 classes. The decoder will then first decide which class a sample belongs to, and then select the appropriate set of coefficients to filter the sample. However, signaling 25 sets of coefficients can be costly. Hence the VVC standard also allows that only a few of the 25 classes are filtered using unique sets of coefficients. The remaining classes may reuse a set of coefficients used in another class, or it may be determined that it should not be filtered at all.

The final output Y_{ALF}, Cb_{ALF}, Cr_{ALF} is then stored in the decoded picture buffer (DPB). From here, it can be output and also be used for temporal prediction of future pictures. Since deblocking, SAO and ALF in this way affect the prediction of future pictures, it is essential that all three sub-stages are done exactly according to the specification, otherwise the decoder will experience drift. Put another way, the deblocking filter, SAO and ALF are inside the coding loop. This is the reason why they are called loop filters.

It should be noted that deblocking, SAO and ALF are just examples of loop filters. There are other loop filters, such as the bilateral filter which is currently part of ECM. ECM is an enhanced compression model with compression capabilities beyond VVC.

### 10. Post-Filters

A post-filter is a filter that can be applied to the picture before it is displayed or otherwise further processed. A post-filter does not affect the contents of the decoded picture buffer (DPB), i.e., it does not affect the samples that future pictures are predicted from. Instead, it may take samples from the DPB and filter them before they are being displayed or further processed. As an example, such further processing can involve scaling the picture to allow it to be rendered in full-screen mode, reencoding the picture (this is known to a person skilled in the art as ‘transcoding’), using machine vision algorithms to extract information from the picture etc. Since a post-filter does not affect the prediction, doing post-filters a bit differently in every decoder does not give rise to drift. Hence it is often not necessary to standardize post-filters. In some codecs, the post-filter may be considered to be part of the decoder, and the samples output from the decoder are the samples output from the post-filter. In other codecs, the post-filter may be considered to be outside the decoder, and the samples output from the decoder are the samples that are inputted to the post-filter. In this document we are covering both cases.

### 11. Neural Network Loop Filters

During the development of the VVC standard, it was experimented to replace ALF with a neural network-based loop filter (abbreviated NN filter from hereon). Hence, instead of feeding the components Y_{SAO}, Cb_{SAO}, and Cr_{SAO} into the ALF, it was instead fed into a neural network filter. The output of the NN filter, i.e., the components Y_{NN}, Cb_{NN}, and Cr_{NN}, could then be stored to the picture buffer to be used for future prediction and display. In some experimental proposals, it was even suggested to combine the neural network loop filter with an ALF, for instance by feeding the output from the NN filter to the input of the ALF. The main difference between ALFs and the NN filters proposed during the VVC standard was that the NN filters often contained several layers of linear filtering interleaved with layers of nonlinear functions. In comparison, ALF can be seen as a two-layer filter; first a non-linear component (classification) followed by a linear component (FIR-filtering). Using a neural network-based loop filter instead of (or in addition to) ALF typically gave a good improvement in terms of compression efficiency, meaning that the same quality could be obtained with fewer bits. However, the many layers of NN filtering gave rise to many multiplications necessary for every finished pixel. As an example, while the ALF tool required at most 18 multiplications per pixel, some loop filters proposed in JVET required 500,000 multiplications per pixel. While this may be feasible for some decoders, such as stationary computers with strong GPUs hooked up to a wired power source, it may not be feasible for a mobile device running off a battery. Since the standard must be decodable on all devices, including ones that are power constrained, it was decided not to include any neural network-based loop filters in the VVC standard. Turning off the filter for lesser capable devices would not have been a satisfactory solution because the filter affects the prediction of future frames and turning the filter off in only the decoder would thus have resulted in drift. If the encoder would know that the receiving decoder would be NN-capable, one solution could be to turn it on only in those cases. Unfortunately, it is typically not possible for the encoder to know which decoders will be used for decoding, since the video may be encoded once but decoded thousands of times by different end users. Hence an encoder would only be able to use this feature for point-to-point communication when capability-handshake would be possible, and this is too limited a use case for it to be interesting to include such a tool into the standard.

### 12. Parameter Sets

HEVC and VVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs, e.g., data for multiple scalability layers in the bitstream.

VVC also specifies one additional parameter set, the adaptation parameter set (APS). The APS carries parameters needed for the ALF tool, the LMCS tool and the scaling list tool.

Both HEVC and VVC allow certain information (e.g., parameter sets) to be provided by external means. “By external means” should be interpreted as the information is not provided in the coded video bitstream but by some other means not specified in the video codec specification, e.g., via metadata possibly provided in a different data channel, as a constant in the decoder, or provided through an API to the decoder.

### 13. Picture Header

In VVC, a coded picture contains a picture header syntax structure. The picture header syntax structure contains syntax elements that are common for all slices of the associated picture. The picture header syntax structure may be signaled in its own non-VCL NAL unit with NAL unit type PH_NUT or included in the slice header given that there is only one slice in the coded picture. This is indicated by the slice header syntax element picture_header_in_slice_header_flag, where a value equal to 1 specifies that the picture header syntax structure is included in the slice header and a value equal to 0 specifies that the picture header syntax structure is carried in its own PH NAL unit. For a CVS where not all pictures are single-slice pictures, each coded picture must be preceded by a picture header that is signaled in its own NAL unit. HEVC does not support picture headers.

### 14. SEI Messages

Supplementary Enhancement Information (SEI) messages are NAL units in the coded bitstream that do not influence the decoding process of coded pictures from VCL NAL units. SEI messages usually address issues of representation/rendering of the decoded bitstream. The overall concept of SEI messages and many of the messages themselves have been inherited from the H.264 and HEVC specifications into the VVC specification.

SEI messages assist in processes related to decoding, display or other purposes. However, SEI messages are not required for constructing the luma or chroma samples by the decoding process. Some SEI messages are required for checking bitstream conformance and for output timing decoder conformance. Other SEI messages are not required for checking bitstream conformance. A decoder is not required to support all SEI messages. Usually, if a decoder encounters an unsupported SEI message, it is discarded.

ITU-T H.274|ISO/IEC 23002-7, also referred to as VSEI, specifies the syntax and semantics of SEI messages and is particularly intended for use with VVC, although it is written in a manner intended to be sufficiently generic that it may also be used with other types of coded video bitstreams. The first version of ITU-T H.274 ISO/IEC 23002-7 was finalized in July 2020. At the time of writing, version 2 is under development.

Neural Network-Based Post-filters Indicated with SEI Message.

One way to avoid the drift associated with the disabling of a NN-based loop filter for less capable devices is to instead us a neural network-based post-filter. This way, capable devices can run the NN-based post-filter, whereas less capable devices may skip it. Since prediction is not done from the NN-filtered samples, skipping NN filtering will not result in any drift.

An example of this was presented in standardization input contribution JVET-X0112. Here, an SEI message is sent along with the bitstream. The SEI message contains a neural network post-filter signaled using the MPEG Neural Network Representation (NNR, ISO/IEC 15938-17) standard. Another example was presented in JVET-Y0059. This SEI message signals that the picture should be filtered using a specific post-filter, and the SEI message also includes bias values (a form of neural network weight) that this specific post-filter should use in order to reach particularly good quality on the group of pictures that the SEI message belongs to. This is similar to the ALF coefficients that are sent from the encoder to the decoder. In contrast to ALF however, it is completely fine for a decoder to ignore these SEI messages and avoid NN post-filtering, since this will not result in drift. The only downside is that the decoder will not get the image quality improvement that the neural network post-filtering would have provided, while still having to pay the price of having part of the bitstream being made up of SEI messages that are of no use to it.

### SUMMARY

Certain challenges presently exist. For instance, while neural network-based post-filtering can solve the issue of differing decoder capabilities, it is still not as capable of improving compression efficiency as much as loop filters can. As an example, JVET-Y0059 brings a BD-rate gain of −2.4% if no bias terms are signaled. This means that the bit rate can be lowered by 2.4% while maintaining image quality. If bias terms are signaled, a BD-rate gain of −4.6% can be obtained with the techniques from the same contribution (JVET-Y0059). However, that is still much less than what can be obtained by neural network-based loop filters. As an example, JVET-X0066 reports a BD-rate gain of −9.8%, more than twice the gain of JVET-Y0059. Thus, there is a need to improve the compression efficiency of neural network-based post-filters.

Accordingly, in one aspect there is provided a method performed by an apparatus comprising a decoder, where the method includes deriving a first set of post-reconstruction samples from a bitstream. The method also includes outputting (e.g., sending out or making available for retrieval) the first set of post-reconstruction samples (e.g., outputting a copy of the first set of post-reconstruction samples to a post-filter). The method also includes filtering the first set post-reconstruction samples using one or more loop filters to produce last loop filter output samples, wherein the last loop filter output samples are not identical to the first set of post-reconstruction samples. The method also include storing the last loop filter output samples in a decoded picture buffer.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory. An advantage of embodiments disclosed herein is that they improve the picture fidelity of post-filtered samples.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of an encoder according to an embodiment.

FIG. 3 is a schematic block diagram of a decoder according to an embodiment.

FIG. 4 is a schematic block diagram of a decoder according to an embodiment.

FIG. 5 is a schematic block diagram of a decoder according to an embodiment.

FIG. 6 is a schematic block diagram of a decoder according to an embodiment.

FIG. 7 is a schematic block diagram of a decoder according to an embodiment.

FIG. 8 is a schematic block diagram of a decoder according to an embodiment.

FIG. 9 is a schematic block diagram of a decoder according to an embodiment.

FIG. 10 is a flowchart illustrating a process according to an embodiment.

FIG. 11 is a block diagram of an apparatus according to an embodiment.

### DETAILED DESCRIPTION

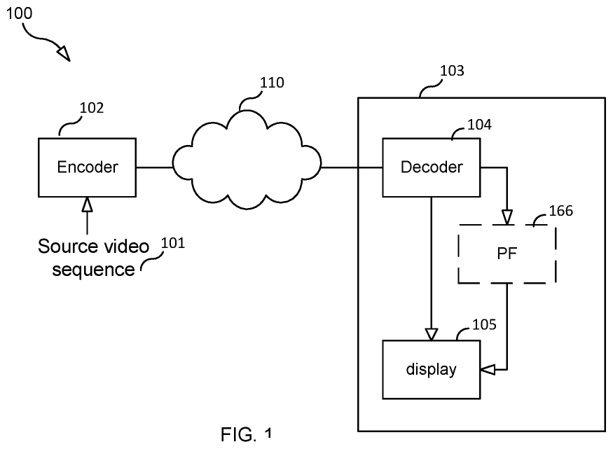

FIG. 1 illustrates a system 100 according to an embodiment. System 100 includes an encoder 102 and a decoder 104, wherein encoder 102 is in communication with decoder 104 via a network 110 (e.g., the Internet or other network). That is, encoder 102 encodes a video sequence 101 into a bitstream comprising an encoded video sequence and transmits the bitstream to decoder 104 via network 108. In some embodiments, rather than transmitting bitstream to decoder 104, the bitstream is stored in a data storage unit. Decoder 104 decodes the pictures included in the encoded video sequence to produce video data for display and/or post processing. Accordingly, decoder 104 may be part of a device 103 either having a display device 105 or connected to a display device. The device 103 may be a mobile device, a set-top device, a head-mounted display, or any other device. Additionally, as shown in FIG. 1, device 103 may include a post-filter (PF) 166 that receives the decoded picture from decoder 104. In the embodiment shown, post-filter 166 is separate from decoder 104, but in other embodiments, post-filter 166 may be a component of decoder 104.

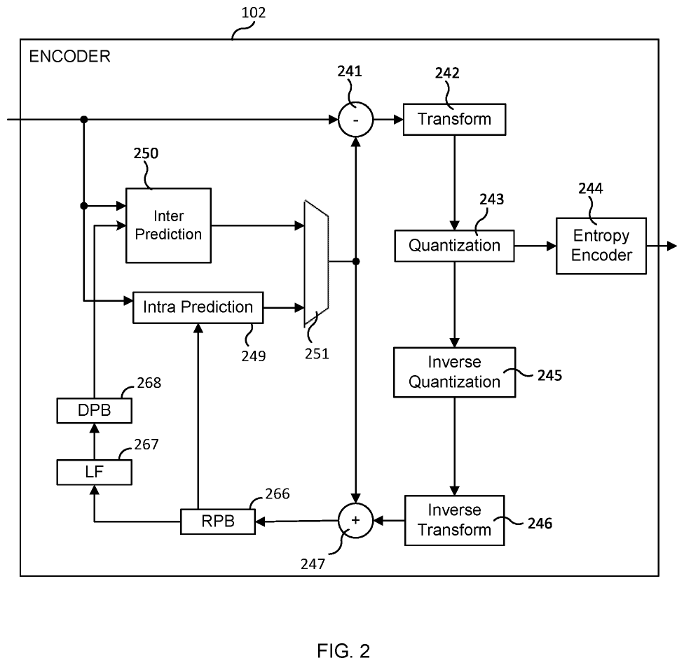

FIG. 2 illustrates functional components of encoder 102 according to some embodiments. It should be noted that encoders may be implemented differently so implementation other than this specific example can be used. Encoder 102 employs a subtractor 241 to produce a residual block which is the difference in pixel values between an input block and a prediction block (i.e., the output of a selector 251, which is either an inter prediction block output by an inter predictor 250 (a.k.a., motion compensator) or an intra prediction block output by an intra predictor 249). Then a forward transform 242 and forward quantization 243 is performed on the residual block as well known in the current art. This produces transform coefficients which are then encoded into the bitstream by encoder 244 (e.g., an entropy encoder) and the bitstream with the encoded transform coefficients is output from encoder 102. Next, encoder 102 uses the transform coefficients to produce a reconstructed block. This is done by first applying inverse quantization 245 and inverse transform 246 to the transform coefficients to produce a reconstructed residual block and using an adder 247 to add the prediction block to the reconstructed residual block, thereby producing the reconstructed block, which is stored in the reconstruction picture buffer (RFB) 266. Loop filtering by a loop filter (LF) stage 267 is applied and the final decoded picture is stored in a decoded picture buffer (DPB) 268, where it can then be used by the inter predictor 250 to produce an inter prediction block for the next picture to be processed. LF stage 267 may include the above described three sub-stages: i) a deblocking filter, ii) an SAO filter, and iii) an ALF.

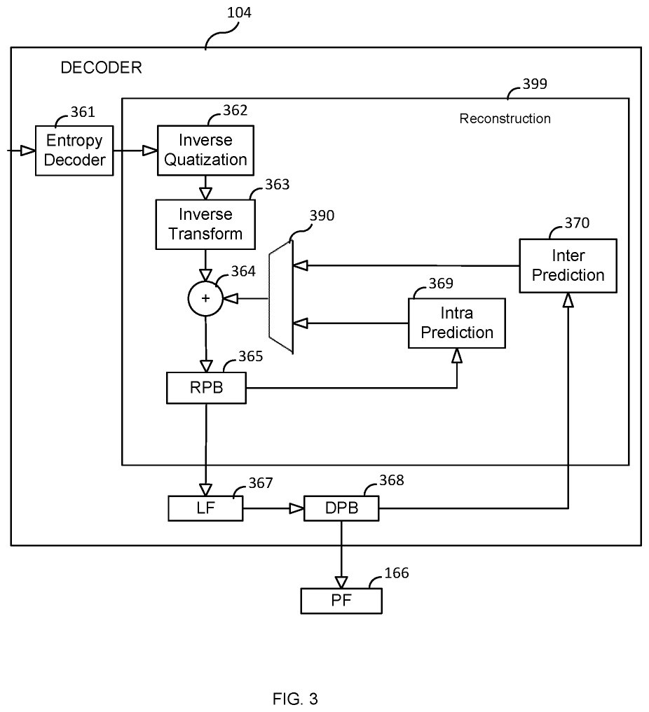

FIG. 3 illustrates functional components of decoder 104 according to some embodiments. It should be noted that decoder 104 may be implemented differently so implementations other than this specific example can be used. Decoder 104 includes a decoder module 361 (e.g., an entropy decoder) that decodes from the bitstream transform coefficient values of a block. Decoder 104 also includes a reconstruction stage 399 in which the transform coefficient values are subject to an inverse quantization process 362 and inverse transform process 363 to produce a residual block. This residual block is input to adder 364 that adds the residual block and a prediction block output from selector 390 to form a reconstructed block. Selector 390 either selects to output an inter prediction block or an intra prediction block. The reconstructed block is stored in a reconstructed picture buffer (RPB) 365. The inter prediction block is generated by the inter prediction module 370 and the intra prediction block is generated by the intra prediction module 369.

Following the reconstruction stage 399, a loop filter stage 367 applies loop filtering and the final decoded picture may be stored in a decoded picture buffer (DPB) 368 and output to PF 166. Pictures are stored in the DPB for two primary reasons: 1) to wait for picture output and 2) to be used for reference when decoding future pictures.

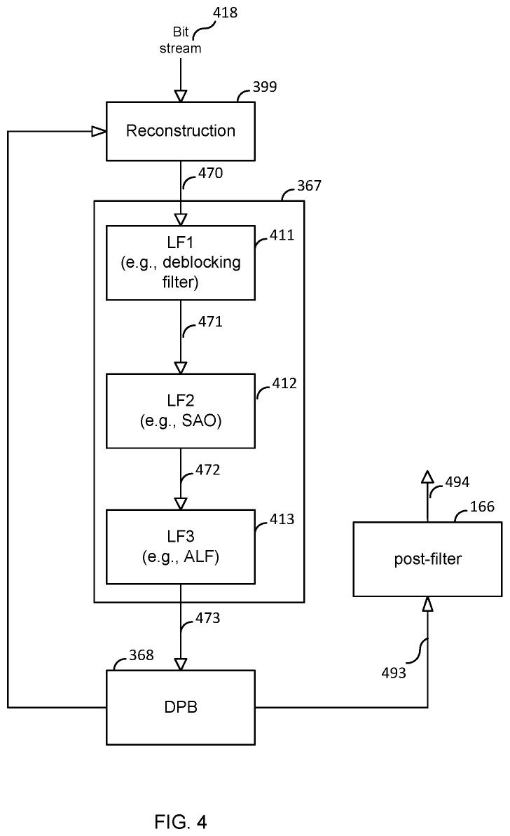

FIG. 4 further illustrates LF 367 according to an embodiment. In the embodiment shown, LF 367 includes three LF sub-stages: i) a first loop filter (LF1) 411, ii) a second loop filter (LF2) 412, and iii) a third loop filter (LF3) 413. As described above, using the bitstream 418 and sample values (or simply “samples” for short”) from DPB 368, the reconstruction stage 399 produces samples 470 that are then loop filtered with one or more loop filters 411, 412, and 413. For example, in the embodiment shown: filter 411 receives samples 470 and filters these samples to produce first filtered samples 471; filter 412 receives the first filtered samples 471 and filters these samples to produce second filtered samples 472; and filter 413 receives the second filtered samples 472 and filters these samples 472 to produce third filtered sample 473 (also denoted as “last loop filter output samples”), which are stored in DPB 368 and provided to PF 166.

The samples 493 input to post-filter 166 (which, in the example shown, are obtained from DPB 368) are denoted “post-filter input samples 493.” The output samples of the post-filter are denoted “post-filter output samples 494.” The samples may comprise samples for a full picture or for a partial picture.

As shown in FIG. 4, the first loop filter 411 may be a deblocking filter, the second loop filter 412 may be an SAO filter, and the third loop filter 413 may be an ALF, all of which are used in VVC. It should be understood, however, that these are just examples of loop filters and that there can be fewer or more than three. In the example shown, ALF is the last loop filter and hence the output samples of ALF (denoted Y_{ALF} Cb_{ALF} Cr_{ALF}) are the last loop filter output samples 473. These samples are then fed to DPB 368. In the example shown, post-filter 166 obtains the last loop filter output samples 473 from DPB 368 (post-filter 166 may obtain samples 473 from DPB 368 at essentially the same time the sample are stored in DPB 368 or after a delay). Hence, in the example shown, post-filter input samples 493 equals the last loop filter output samples 473 sent to the DPB 368, possibly at an earlier time (e.g., post-filter input samples 493 may be sent to post-filter 166 several video frames after the samples 473 are sent to DPB 368). The reason why there may be this delay is to allow the pictures sent to the post-filter 166 to be in display order while the pictures sent to DPB 368 are in decoding order.

One problem with using LF 367 is that the loop filtering performed by LF 367 can destroy information. Hence, having post-filter 166 process the samples only after ALF 413 has ‘destroyed them’ can therefore be undesirable. As an example, the post-filter may be a NN filter with thousands of multiplications per sample whereas the loop filter may be specified to only use, say, twelve multiplications per sample.

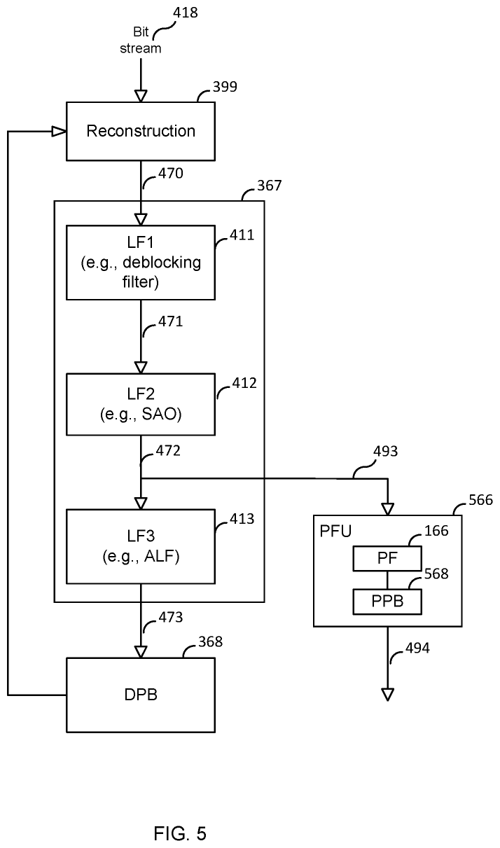

Hence, this disclosure provides that the decoder may output samples (e.g., send out to a post-filter or make available to the post-filter) that have not been loop-filtered with one or more (or any) of the loop filters of LF 367. This way post-filter 166 can be given or retrieve non-filtered, non-destroyed samples from before a loop filter or loop filters and do a better job filtering them. In some embodiments, the decoder must still filter the samples that are put into the decoded picture buffer used for prediction with the specified loop filters, so as to avoid drift. In some embodiments, the post-filter 166, in addition to the non-loop filtered samples, also gets the loop filtered samples as input. In yet other embodiments, in addition to getting the non-loop filtered samples, the post-filter also gets the bitstream (the entire or parts thereof) as input. In yet other embodiments, in addition to getting the non-loop filtered samples, the post-filter also gets parameters that have been extracted from the bitstream. As an example, the post-filter may want to do its own filtering with the help of the ALF parameters that the encoder has sent. This filtering may be different from, and better than, the filtering that the ALF loop filter would do with the same ALF parameters. Because the order in which decoder 104 decodes pictures (often denoted the ‘decoding order’) may be different from the order in which the pictures are displayed or output (often denoted the ‘display order’ or ‘output order’), it may be necessary to store the samples in a buffer to change the order. This buffer may be separate from DPB 368 and is denoted the post-filter picture buffer (PPB), and it may be placed before post-filter 166 or after post-filter 166, or it may be a part of post-filter 166. In some cases, such as when using low-delay configurations, a PPB may not be necessary. In some embodiments, the PPB is integrated into the DPB such that the DPB stores both the last loop filter output samples 473 and the post-reconstruction samples. In some implementations with post-filtering, the DPB stores both the last loop filter output samples 473 and the post-filter output samples. Although the DPB and PPB are illustrated as different units in FIG. 5-9, they should throughout this disclosure be seen as possibly merged into one buffer.

### 1. Using Post-Reconstruction Samples as Input to the Post-Filter

FIG. 5 illustrates an embodiment. In the embodiment shown, samples that come from a point in the decoding chain after the reconstruction stage 399 but before the last loop filter 413 are i) output (e.g., pushed to post-filter 166 or retrieved by post-filter 166) and ii) further loop filtered. These samples are denoted “post-reconstruction samples.” In FIG. 5, the post-reconstruction samples are the samples 472 produced by filter 412. As shown, in this embodiment, these samples 472 are output to the post-filter 166 and also are provided to LF3 413 for further filtering. For instance, a copy of samples 472 are output to post-filter 166. Hence, the post-filter input samples 493 are identical to the samples 472, but different from the last loop filter output samples 473 (that is, the samples 472 provided to post-filter 166 are not filtered by LF3 413). As shown in FIG. 5, post-filter (PF) 166 is a component of a post-filter unit (PFU) 566 that also may include a PPB 568. Hence, samples 472 are output directly to PF 166 or output indirectly via PPB 568 if the PPB 568 is located between PF 166 and the input to PFU 566.

Like the embodiment shown in FIG. 4, in the embodiment of FIG. 5 the last loop filter output samples 473 are fed to DPB 368. Hence in this embodiment we have that DPB input samples equal last loop filter output samples 473, and post-filter input samples 493 equal samples 472. Hence, the last loop filter output samples 473 are not provided to post-filter 166 in this example. It should be noted that for the last loop filter output samples 473 to be different from the post-filter input samples 493, the loop filter 413 cannot always do the identity transform, because then these two signals (473 and 493) become equivalent.

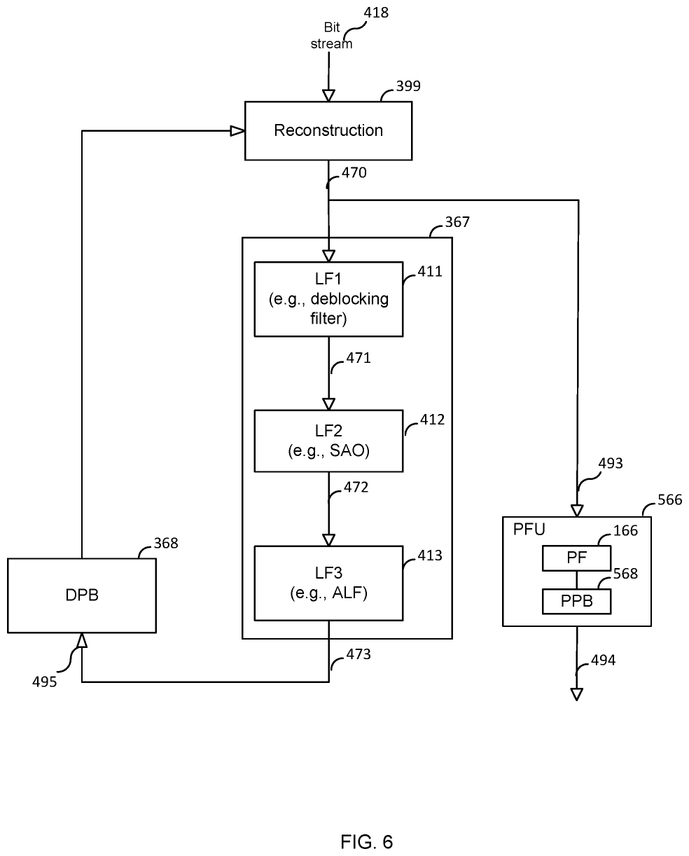

FIG. 6 illustrates another embodiment. In this embodiment, the post-reconstruction samples input to PFU 566 (and, therefore, input to PF 166 either directly or via PPB 568) are the samples 470 output from reconstruction stage 399.

In this embodiment, the DPB input samples are the samples 473 output from filter 413; post-filter input samples 493 are the samples 470 output by the reconstruction stage 399. Hence, the post-filter input samples 493 are not the samples 473 output from filter 413.

In one embodiment, the decoder will output post-reconstructed samples (e.g., samples 470, 471, or 472), while the samples put into DPB 368 will be samples that have been filtered by all of the loop filters. This embodiment may consist of a decoding method without there being any post-filter. In this embodiment, the decoder decodes the bitstream, including applying one or more loop filters, to generate the DPB input samples. These DPB input samples are stored in DPB 368 and may be used for prediction in the decoding process of future pictures. In the art, the decoder would output the DPB input samples. However, in this embodiment, the decoder instead output samples that come from a point in the decoding chain after the reconstruction but before the last loop filter. This means that the samples that are output (which are the post-reconstruction samples) are subject to one or more in-loop filters before the samples are stored in DPB 368. In this embodiment, there may be a PPB that enables reordering of samples from decoding order to display order.

Accordingly, in this embodiment, a method for decoding a current picture from a bitstream may include the following steps:

Step 1: derive post-reconstruction samples from the bitstream. This is typically done in the decoding process. The post-reconstruction samples come from a point in the decoding chain after the reconstruction but before the last loop filter 413 (e.g., the post-reconstruction samples may be samples 471 output from filter 411, samples 472 output from filter 412, or samples 470 output from reconstruction stage 399).

Step 2: filter the post-reconstruction samples using one or more loop filters to obtain last loop filter output samples (e.g., samples 473). The one or more loop filters may for instance be an ALF, an SAO filter, or an NN-based loop filter.

Step 3: store the last loop filter output samples 473 in the DPB.

Step 4: output the post-reconstruction samples from the decoder. In one embodiment the output in this step is done by external means. For example, a post-filter or other tool can use a decoder API to request the post-reconstruction samples from the decoder. This may be implemented such that the API provides a pointer to the post-reconstruction samples. Optionally, using a buffer (e.g., PPB, DPB) the post-reconstruction samples may be reordered by a before being output.

Optionally, the decoder may use the last loop filter output samples, that are stored in DPB 368, in the decoding process of a picture that follows the current picture in decoding order.

In a second version of this embodiment, post-filter 166 is used to filter the post-reconstruction samples. Hence, the following steps may be performed:

Step 1: obtain a bitstream (the bitstream, which is typically a video bitstream, may for instance be obtained after transmitted over a network or may be obtained from a storage unit).

Step 2: derive post-reconstruction samples from the bitstream.

Step 3: filter the post-reconstruction samples using one or more loop filters to obtain last loop filter output samples.

Step 4: store the last loop filter output samples in DPB 368.

Step 5: apply post-filter 166 with the post-reconstruction samples as input to derive post-filter output samples 494 (the post-filter may for instance be a NN-based post-filter).

Step 6: output the derived post-filter output samples.

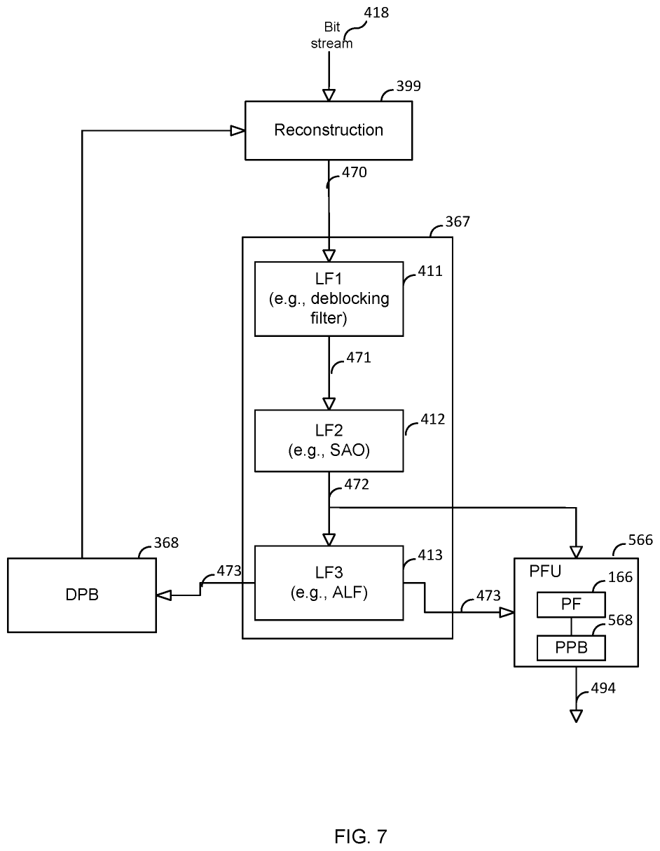

FIG. 7 illustrates an embodiment in which both post-reconstruction samples (e.g., samples 472 in this example) and the last loop filter output samples 473 (directly from the last loop filter 413 (shown) or indirectly via the DPB 368 (not shown)) are used as input to the post-filter 166 (e.g., as input to PPB 568 from which post-filter 166 obtains the samples). In this alternative the decoder may additionally output the last loop filter output samples 473.

Using More than One Post-Reconstructed Picture as Input to the Post-Filter

The post-reconstruction samples may comprise samples for a full picture or for a partial picture. In an alternative version, the post-reconstruction samples may comprise samples for more than one picture, where each comes from multiple points in the decoding chain after the reconstruction but before the last loop filter.

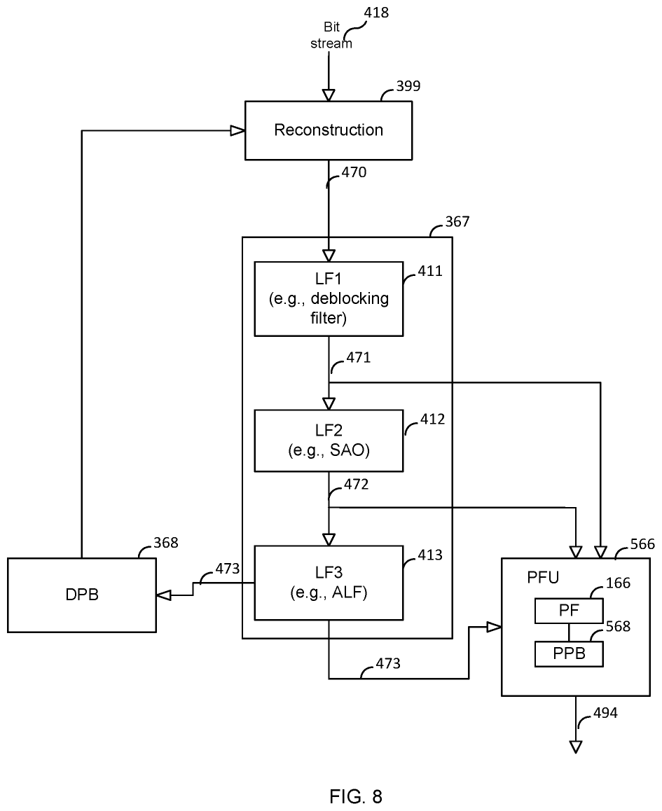

FIG. 8 illustrates an embodiment in which, multiple post-reconstructed samples (i.e., samples 471 and 472 in the example shown) for more than one picture and the last loop filter output samples 473 (directly from the last loop filter 413 (shown) or indirectly via the DPB 368 (not shown)) are provided to post-filter 166 (directly or via PPB 568). As shown in FIG. 8, the post-reconstructed samples for a first picture coming from after LF1 but before LF2, and the post-reconstructed samples for a second picture coming from after the SAO loop filter but before the ALF loop filter, are used as input to the post-filter together with the last loop filter output samples.

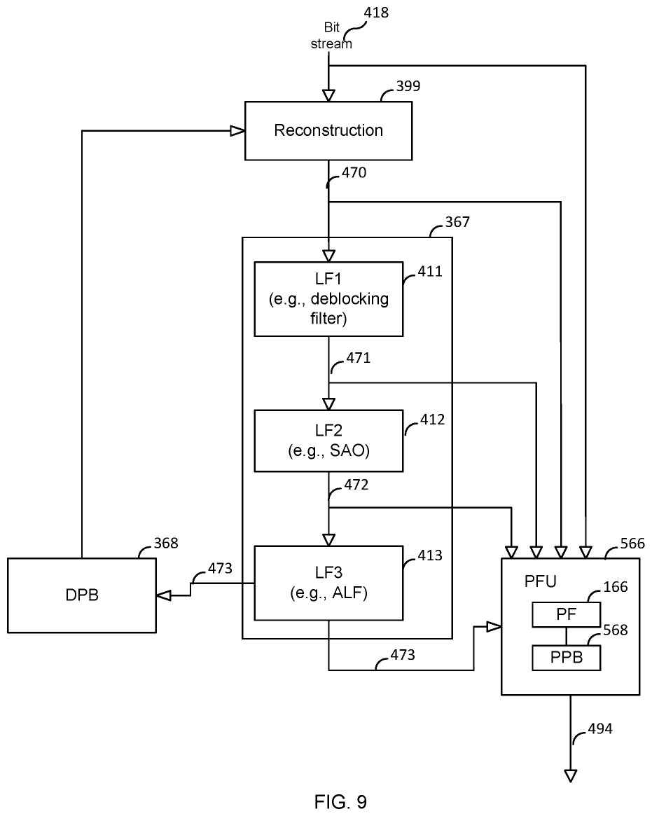

FIG. 9 illustrates an embodiment where one or more of post-reconstruction samples 470, 471, 472 and the last loop filter output samples 473 (directly from the last loop filter 413 (shown) or indirectly via the DPB 368 (not shown)) are used as input to post-filter 166 (directly or via PPB 568). In a second embodiment, at least one of 470, 471, 472 is used as input to post-filter 166. FIG. 9 also illustrate that all or parts of the bitstream and/or parameter values derived from the bitstream may optionally also be input to the post-filter 166 in addition to the post-reconstructed samples.

### Indicator for Determining What Samples to Output

In one embodiment, an indicator value is used to determine what types of samples to output from the decoder. In one embodiment the indicator value is decoded from one or more syntax elements in the bitstream. The indicator may for instance be decoded from an SPS, PPS, picture header (PH), an SEI message or similar structure. The indicator is different from the picture output flag that is present in both HEVC and VVC. While the picture output flag specifies which pictures from DPB 368 to output from the decoder, the indicator of this embodiment indicates the point (or points) in the decoding chain the samples to be output from the decoder is taken from. Referring to FIG. 5, the indicator may specify whether samples 470, 471 or 472 shall be output. In the case there are only two loop filters in the decoding chain, e.g., there is no LF2 412, the indicator may specify whether to output samples 470 or 471. Note that for all options, the samples that are output differ from the samples that are stored in DPB 368. The indicator may be a binary flag or a parameter with more than two values. In one embodiment, the indicator value specifies whether to output the post-reconstructed samples or not from the decoder. In this version the post-reconstructed samples may be outputted in addition to the last post-filter output samples (e.g., samples 473). This is exemplified in the syntax and semantics below with a flag, sps_output_post-reconstructed_samples in SPS. However, the location of the flag could as described above alternatively be present in e.g., the PPS, the PH, and SEI message or similar structure.

TABLE 1

| | Descriptor |
|---|---|
| seq_parameter_set_rbsp( ) { | |
| ... | ... |
| sps_output_post-reconstructed_samples | u(1) |
| ... | ... |
| } | |

In one embodiment, when sps_output_post-reconstructed_samples is equal to 1 this specifies that post-reconstructed samples are output from the decoder; while sps_output_post-reconstructed_samples equal to 0 specifies that post-reconstructed samples are not output from the decoder.

In another embodiment, the indicator value specifies whether to output the post-reconstructed samples or the last post-filter output samples from the decoder. This is exemplified with the same syntax as above but with a slightly different semantics for the flag as follows: when sps_output_post-reconstructed_samples is equal to 1 this specifies that post-reconstructed samples are output from the decoder and that the last post-filter output samples are not output from the decoder; while sps_output_post-reconstructed_samples equal to 0 specifies that the last post-filter output samples are output from the decoder and that post-reconstructed samples are not output from the decoder.

In another embodiment, the indicator value specifies one of the following: i) the post-reconstructed samples are outputted from the decoder; ii) the last loop filter output samples are outputted from the decoder, or iii) both the post-reconstructed samples and the last loop filter output samples are outputted from the decoder.

In another embodiment, the point in the decoding chain from where to output samples from the decoder is specified by the indicator value. The possible options may comprise one or more of the following: i) Output post-reconstructed samples after reconstruction but before deblocking, ii) Output post-reconstructed samples after deblocking but before SAO, iii) Output post-reconstructed samples after SAO but before ALF, iv) or Output the last loop filter output samples.

In one embodiment the indicator is decoded from the same NAL unit as the information describing the post-filter, e.g., in a post-filter SEI message.

In another embodiment the indicator value is not decoded from the bitstream but derived by external means. “By external means” should be interpreted as the information is not provided in the coded video bitstream but by some other means not specified in the video codec specification, e.g., via metadata possibly provided in a different data channel, as a constant in the decoder, or provided through an API to the decoder.

In one embodiment, device 103 may perform the following steps:

Step 1: obtain a bitstream (the bitstream, which is typically a video bitstream, may for instance be obtained after transmitted over a network).

Step 2: derive post-reconstruction samples from the bitstream. This is typically done in the decoding process. The post-reconstruction samples come from a point in the decoding chain after the reconstruction but before the last loop filter. The post-reconstruction samples may comprise samples for a full picture or for a partial picture. In one version, the post-reconstruction samples may comprise samples for more than one picture coming from multiple points in the decoding chain after the reconstruction but before the last loop filter.

Step 3: filter the post-reconstruction samples using one or more loop filters to obtain last loop filter output samples. The one or more loop filters may for instance be an ALF, a SAO filter or an NN-based loop filter.

Step 4: store the last loop filter output samples in DPB 368.

Step 5: obtain an indicator value (the indicator value may be decoded from one or more syntax elements from the bitstream (e.g., from an a SPS, PPS, PH or SEI message) or derived by external means).

Step 6: based on the value of the indicator value, do one of the following: i) output the post-reconstructed samples from the decoder, ii) output the last loop filter output samples from the decoder, iii) output both the post-reconstructed samples and the last loop filter output samples from the decoder.

Step 7: apply post-filter 166 with the samples outputted from the decoder as input to derive post-filter output samples (the post-filter may for instance be a NN-based post-filter).

Step 8: output the derived post-filter output samples 494.

In one embodiment, there is no post-filter and the method above stops after step 6.

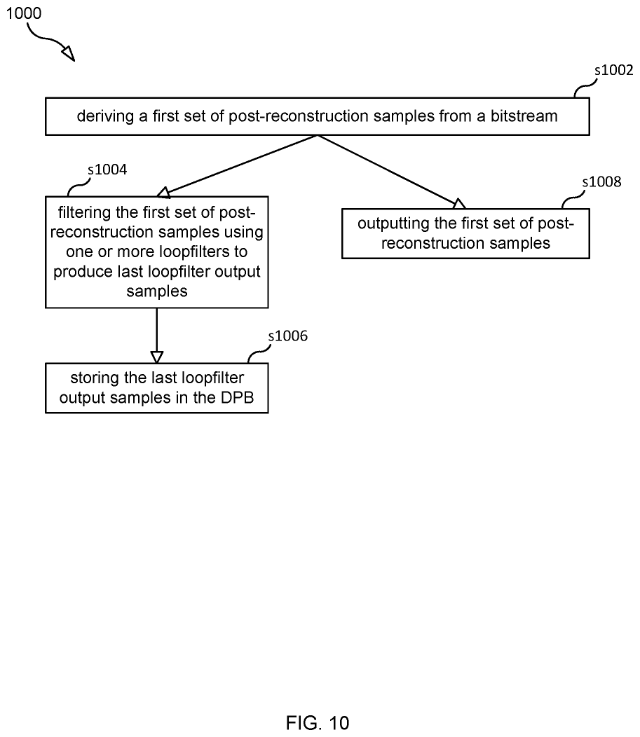

FIG. 10 is a flowchart illustrating a process 1000 according to some embodiments which may be performed by device 103 (e.g., some or all of the steps may be performed by decoder 104). Process 1000 may begin in step s1002.

Step s1002 comprises deriving a first set of post-reconstruction samples (e.g., samples 470, samples 471, and/or samples 472) from a bitstream.

Step s1004 comprises filtering the first set post-reconstruction samples using one or more loop filters (e.g., LF 411, LF 412, and/or LF 413) to produce last loop filter output samples (e.g., samples 473), wherein the last loop filter output samples are not identical to the first set of post-reconstruction samples.

Step s1006 comprises storing the last loop filter output samples in a DPB (e.g., DPB 368).

Step s1008 comprises outputting the first set of post-reconstruction samples (e.g., a copy of the first set of post-reconstruction samples may be output).

In some embodiments, outputting the first set of post-reconstruction samples comprises providing the first set of post-reconstruction samples to a post-filter 166, which is configured to process the first set of post-reconstruction samples (e.g., the samples may be automatically sent directly to post-filter 166 or sent indirectly to post-filter 166 via, for example, a buffer (e.g., PPB, DPB), or the post-reconstruction samples may be stored in a buffer (e.g., DPB) and post-filter 166 may use an API to request the post-reconstruction samples).

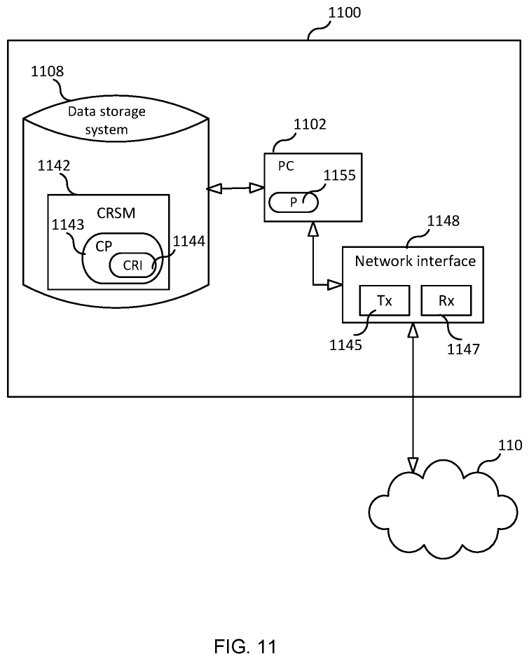

FIG. 11 is a block diagram of an apparatus 1100 for implementing device 103, according to some embodiments. As shown in FIG. 11, apparatus 1100 may comprise: processing circuitry (PC) 1102, which may include one or more processors (P) 1155 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1100 may be a distributed computing apparatus); at least one network interface 1148 comprising a transmitter (Tx) 1145 and a receiver (Rx) 1147 for enabling apparatus 1100 to transmit data to and receive data from other nodes connected to a network 110 (e.g., an Internet Protocol (IP) network) to which network interface 1148 is connected (directly or indirectly) (e.g., network interface 1148 may be wirelessly connected to the network 110, in which case network interface 1148 is connected to an antenna arrangement); and a storage unit (a.k.a., “data storage system”) 1108, which may include one or more non-volatile storage devices and/or one or more volatile storage devices. In embodiments where PC 1102 includes a programmable processor, a computer readable storage medium (CRSM) 1142 may be provided. CRSM 1142 stores a computer program (CP) 1143 comprising computer readable instructions (CRI) 1144. CRSM 1142 may be a non-transitory computer readable storage medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes apparatus 1100 to perform steps described herein (e.g., steps described herein with reference to the flow charts). In other embodiments, apparatus 1100 may be configured to perform steps described herein without the need for code. That is, for example, PC 1102 may consist merely of one or more ASICs. Hence, the features of the embodiments described herein may be implemented in hardware and/or software.

### SUMMARY OF VARIOUS EMBODIMENTS

1. A method (1000) for processing an encoded picture, the method comprising: deriving (s1002) a first set of post-reconstruction samples (470, 471, 472) from a bitstream; filtering (s1004) the first set post-reconstruction samples using one or more loop filters (411, 412, 413) to produce last loop filter output samples (473), wherein the last loop filter output samples (473) are not identical to the first set of post-reconstruction samples (470, 471, 472); storing (s1006) the last loop filter output samples (473) in a decoded picture buffer, DPB (368); and outputting (s1008) the first set of post-reconstruction samples (e.g., outputting a copy of the first set of post-reconstruction samples).

2. The method of embodiment 1, wherein outputting the first set of post-reconstruction samples comprises providing the first set of post-reconstruction samples to a post-filter (166) configured to process the first set of post-reconstruction samples (470, 471, 472).

3. The method of embodiment 2, wherein the method is performed by a decoder (102) and the post-filter (166) is a component of the decoder (102).

4. The method of embodiment 2 or 3, wherein the first set of post-reconstructed samples are the only samples used as input to the post-filter (166).

5. The method of any one of embodiments 1-4, wherein the first set of post-reconstruction samples correspond to a first picture.

6. The method of any one of embodiments 1-4, wherein the first set of post-reconstruction samples correspond to a portion of a picture.

7. The method of any one of embodiments 1-6, wherein filtering (s1006) the first set of post-reconstruction samples using one or more loop filters (411, 412, 413) to produce the last loop filter output samples (473) comprises: filtering the first set of post-reconstruction samples using a first loop filter (411) to produce first filtered samples (471); filtering the first filtered samples (471) using a second loop filter (411) to produce second filtered samples (472); and filtering the second filtered samples (471) using a third loop filter (413) to produce the last loop filter output samples (473).

8. The method of embodiment 7, further comprising at least one of: providing to a post-filter (166) the first filtered samples (471); providing to the post-filter (166) the second filtered samples (472).

9. The method of any one of embodiments 1-6, wherein deriving (s1002) the first set of post-reconstruction samples (471, 472) comprises obtaining initial post-reconstruction samples (470) and filtering the initial post-reconstruction samples using one or more filters (411, 412) to produce the first set of post-reconstruction samples (471, 472).

10. The method of embodiment 9, wherein deriving (s1002) the first set of post-reconstruction samples (471, 472) comprises obtaining initial post-reconstruction samples (470) and filtering the initial post-reconstruction samples using a first filter (411) to produce the first set of post-reconstruction samples (471, 472).

11. The method of embodiment 10, wherein filtering (s1006) the first set of post-reconstruction samples using one or more loop filters (412, 413) to produce the last loop filter output samples (473) comprises: filtering the first set of post-reconstruction samples using a second loop filter (412) to produce second filtered samples (472); and filtering the second filtered samples (471) using a third loop filter (413) to produce the last loop filter output samples (473).

12. The method of embodiment 9, wherein deriving (s1002) the first set of post-reconstruction samples (471, 472) comprises: obtaining initial post-reconstruction samples (470); filtering the initial post-reconstruction samples using a first filter (411) to produce first filtered samples (471); and filtering the first filtered samples using a second filter (412) to produce second filtered samples (472), wherein the first set of post-reconstruction samples are the second filtered samples.

13. The method of embodiment 12, further comprising: providing to a post-filter (166) the initial post-reconstruction samples (470); and/or providing to the post-filter (166) the first filtered samples (471).

14. The method of any one of embodiments 1-13, wherein the first set of post-reconstruction samples comprises samples from more than one picture.

15. The method of any one of embodiments 1-14, wherein the method further comprises providing to a post-filter both the first set of post-reconstruction samples and the last loop filter output samples.

16. The method of any one of embodiments 1-15, wherein the method is performed by a decoder coupled to a post-filter, and the first set of post-reconstruction samples is output from the decoder to the post-filter.

17. The method of any one of embodiments 1-16, wherein the one or more loop filters comprises one or more of a deblocking filter, an ALF, a SAO filter, a bilateral filter, or an NN-based loop filter.

18. The method of embodiment 2 and any embodiment dependent on embodiment 2, wherein the post-filter is a neural network-based filter.

19. The method of embodiment 2 and any embodiment dependent on embodiment 2, wherein all or parts of the bitstream, and/or parameter values derived from the bitstream, are inputs to the post-filter in addition to the post-reconstructed samples.

20. The method of any of the previous embodiments, further comprising: deriving an indicator value from one or more syntax elements in the bitstream or by external means, the indicator value specifying the first set of post-reconstruction samples.

21. The method of embodiment 20, further comprising, in response to the indicator value having a first value, output the first set of post-reconstruction samples.

22. The method of embodiment 20, further comprising, in response to the indicator value having a second value, output the first set of post-reconstruction samples and also output the last loop filter output samples.

23. The method of any of embodiments 20-22, wherein the indicator is derived from at least one of a SPS, PPS, PH or SEI message.

24. A computer program (1143) comprising instructions (1144) which when executed by processing circuitry (1102) of an apparatus (1100) causes the apparatus to perform the method of any one of embodiments 1-23.

25. A carrier containing the computer program of embodiment 24, wherein the carrier is one of an electronic signal, an optical signal, a radio signal, and a computer readable storage medium (1142).

26. An apparatus (1100) that is configured to: derive (s1002) a first set of post-reconstruction samples (470, 471, 472) from a bitstream; filter (s1004) the first set post-reconstruction samples using one or more loop filters (411, 412, 413) to produce last loop filter output samples (473), wherein the last loop filter output samples (473) are not identical to the first set of post-reconstruction samples (470, 471, 472); and store (s1006) the last loop filter output samples (473) in a decoded picture buffer, DPB (368); and output (s1008) the first set of post-reconstruction samples (e.g., outputting a copy of the first set of post-reconstruction samples).

27. The apparatus of embodiment 26, wherein the apparatus is further configured to perform the method of any one of embodiments 2-23.

While the terminology in this disclosure is described in terms of VVC, the embodiments of this disclosure also apply to any existing or future codec, which may use a different, but equivalent terminology.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for processing an encoded picture, the method comprising:
deriving a first set of post-reconstruction samples from a bitstream;
filtering the first set of post-reconstruction samples using one or more loop filters to produce last loop filter output samples, wherein the last loop filter output samples are not identical to the first set of post-reconstruction samples;
storing the last loop filter output samples in a decoded picture buffer, DPB; and
outputting the first set of post-reconstruction samples; and
providing to a post-filter both the first set of post-reconstruction samples and the last loop filter output samples.

2. (canceled)

3. The method of claim 2, wherein the method is performed by a decoder and the post-filter is a component of the decoder.

4. (canceled)

5. The method of claim 1, wherein the first set of post-reconstruction samples correspond to a first picture.

6. The method of claim 1, wherein the first set of post-reconstruction samples correspond to a portion of a picture.

7. The method of claim 1, wherein
filtering the first set of post-reconstruction samples using one or more loop filters to produce the last loop filter output samples comprises:
filtering the first set of post-reconstruction samples using a first loop filter to produce first filtered samples;
filtering the first filtered samples using a second loop filter to produce second filtered samples; and
filtering the second filtered samples using a third loop filter to produce the last loop filter output samples.

8. The method of claim 7, further comprising at least one of:
providing to the post-filter the first filtered samples;
providing to the post-filter the second filtered samples.

9. The method of claim 1, wherein
deriving the first set of post-reconstruction samples comprises obtaining initial post-reconstruction samples and filtering the initial post-reconstruction samples using one or more filters to produce the first set of post-reconstruction samples.

10. (canceled)

11. The method of claim 9, wherein filtering the first set of post-reconstruction samples using one or more loop filters to produce the last loop filter output samples comprises:
filtering the first set of post-reconstruction samples using a second loop filter to produce second filtered samples; and
filtering the second filtered samples using a third loop filter to produce the last loop filter output samples.

12. The method of claim 9, wherein deriving the first set of post-reconstruction samples comprises:
obtaining initial post-reconstruction samples;
filtering the initial post-reconstruction samples using a first filter to produce first filtered samples; and
filtering the first filtered samples using a second filter to produce second filtered samples, wherein the first set of post-reconstruction samples are the second filtered samples.

13. The method of claim 12, further comprising:
providing to the post-filter the initial post-reconstruction samples; and/or
providing to the post-filter the first filtered samples.

14. The method of claim 1, wherein the first set of post-reconstruction samples comprises samples from more than one picture.

15. (canceled)

16. The method of claim 1, wherein
the method is performed by a decoder coupled to the post-filter, and
the first set of post-reconstruction samples is output from the decoder to the post-filter.

17. The method of claim 1, wherein the one or more loop filters comprises one or more of a deblocking filter, an ALF, a SAO filter, a bilateral filter, or an NN-based loop filter.

18. The method of claim 1, wherein the post-filter is a neural network-based filter.

19. The method of claim 1, wherein all or parts of the bitstream, and/or parameter values derived from the bitstream, are inputs to the post-filter in addition to the post-reconstructed samples.

20. The method of claim 1, further comprising:
deriving an indicator value from one or more syntax elements in the bitstream or by external means, the indicator value specifying the first set of post-reconstruction samples.

21. The method of claim 20, further comprising:
in response to the indicator value having a first value, output the first set of post-reconstruction samples; and
in response to the indicator value having a second value, outputting the first set of post-reconstruction samples and also output the last loop filter output samples.

22. (canceled)

23. The method of claim 20, wherein the indicator is derived from at least one of a SPS, PPS, PH or SEI message.

24. A non-transitory computer readable storage medium storing a computer program comprising instructions which when executed by processing circuitry of an apparatus causes the apparatus to perform the method of claim 1.

25. (canceled)

26. An apparatus comprising:
memory; and
processing circuitry, wherein the apparatus is configured to:
derive a first set of post-reconstruction samples from a bitstream;
filter the first of set post-reconstruction samples using one or more loop filters to produce last loop filter output samples, wherein the last loop filter output samples are not identical to the first set of post-reconstruction samples; and
store the last loop filter output samples in a decoded picture buffer, DPB;
output the first set of post-reconstruction samples; and
provide to a post-filter both the first set of post-reconstruction samples and the last loop filter output samples.

27. (canceled)
